(19) United States
(12) Patent Application Publication
(10) Pub. No.: US 2014/0163733 A1
(43) Pub. Date: Jun. 12, 2014

(54) SYSTEM FOR CONTROLLING A ROBOT'S COLLISION WITH AN OBSTACLE, A ROBOT EQUIPPED WITH SUCH A SYSTEM AND A METHOD OF CONTROLLING A ROBOT'S COLLISION WITH AN OBSTACLE

(71) Applicant: Robotics Inventions, Warszawa (PL)

(72) Inventors: Marek SADOWSKI, Gdynia (PL); Roman IWASZKO, Warszawa (PL); Franciszek MIKLASZEWICZ, Warszawa (PL); Jedrzej DROZDOWICZ, Warszawa (PL)

(73) Assignee: Robotics Inventions, Warszawa (PL)

(21) Appl. No.: 14/102,808

(22) Filed: Dec. 11, 2013

(30) Foreign Application Priority Data
Dec. 11, 2012 (PL) P-401996

(51) Int. Cl. B25J 9/16

(52) U.S. Cl. CPC B25J 9/1676
USPC 700/255

(57) ABSTRACT

The invention is related to a system for controlling a robot collision with an obstacle, characterized by having an electronics system (1), and at least one accelerometer (3), that is fixed to a robot and is connected with an electronics system (1), that is configured or programmed in such a way that upon a signal from an accelerometer (3) a robot heading direction or velocity is changed or a robot is stopped.

In addition, the invention comprises a robot equipped with such an electronics system, and a method of controlling a robot collision with an obstacle.

A system for controlling a robot's collision with an obstacle, a robot equipped with such a system and a method of controlling a robot's collision with an obstacle

The object of the Invention is a system for controlling a robot's collision with an obstacle, a robot equipped with such system and a method of controlling robot's collision with an obstacle. The invention relates to mobile robots, home robots, telepresence robots, cleaning robots, vacuuming robots, mopping robots, scrubbing or sweeping robots, lawn mowing robots, personal robots (designed for protection and for aid in homes), EOD robots, inspection robots, agricultural robots, feeding robots, marine robots, submerged robots, airborne robots, space probe robots, as well as robot manipulation arms.

To protect a robot in case of a collision with an obstacle , known in prior art of works mobile robots, such as vacuum cleaners, have a mechanical bumper consisting of an element mounted on one or more hinges, or a yielding element which on contact with an obstacle depresses, triggering a switch mechanically. Consequently, the robot stops or changes direction of movement—for example, withdraws or avoids the obstacle. There may be more of aforementioned elements (eg central , left and right), or element can be mounted on two or more hinges and respectively have two or more switches. For example, when mounted with two hinges, left switch will work properly on collision with an obstacle from the left or right switch on collision with an obstacle on the right side . Two switches will act simultaneously on the central impact.

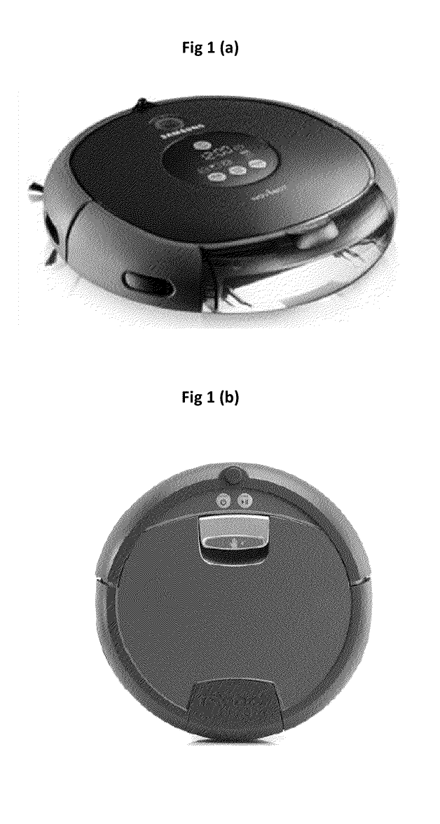

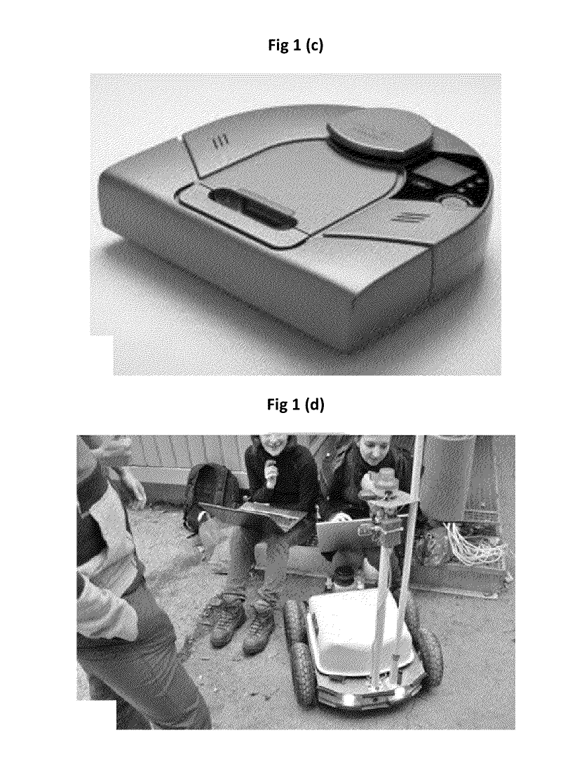

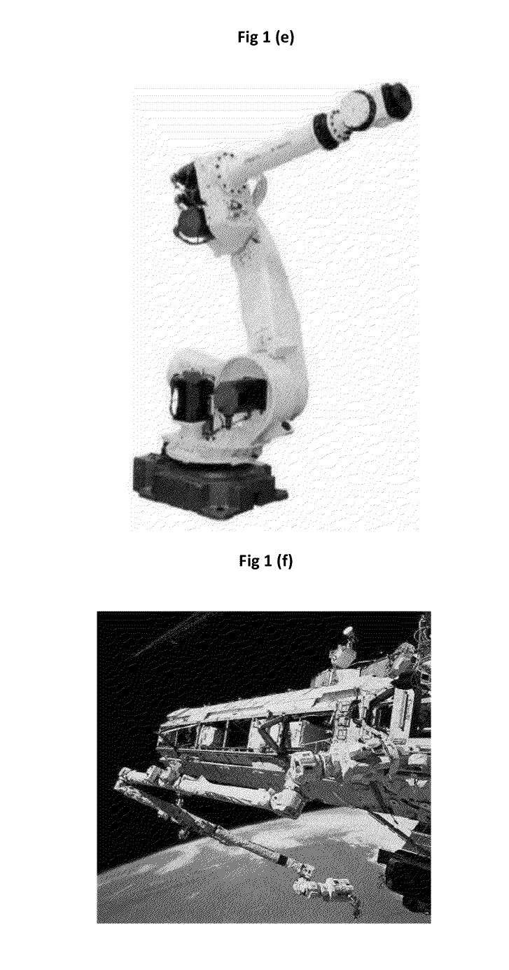

Instead of the bumpers, a conductive rubber is used, which corresponds to one mechanical switch and acts under strong tension in such way that it shorts an outer cover with the inner part—which conducts an electrical impulse and transmits it to the robot. Consequently, the robot stops or changes the direction of movement—for example, withdraws or avoids the obstacle. Sample pictures of commercially available robots using the above-described structures, are illustrated in FIG. 1 (technology level)—a) Samsung NaviBot vacuum, in the foreground mechanical front bumper, side bumper made of rubber is connected to the other side of the bumper with transparent joint, which is also a part of the bumper, b) iRobot Scooba domestic robotic mop; semicircular mechanical bumper is visible in the picture on the top of the robot, c) Neato XV11 vacuum cleaner; in the foreground flat central mechanical bumper—in the picture on the left side of the robot, d) an inspection and patrol robot, Robotics Inventions A-Bot Light, which uses a conductive rubber for the detection of a collision on the front and rear of the robot (shown in the bottom of the photo, near the lights of the robot, e) Fanuc robot arm (no sensor) image from http://abrasit.com/yahoo_site_admin/assets/images/2000i.3291917_std.JPG, f) Canda Arm 2 robot aboard the International Space Station (ISS).

The above-described well known mechanical solutions have two disadvantages. Firstly, it is necessary to implement a mechanical bumper with a number of hinges, springs, and mechanical switches aging as the device is being used, responsible for generating the electrical state 0, 1 or slope 0/1, 1/0. Additional components increase the mass of the robot and, consequently, energy consumption from the batteries (or other fuel consumption) during robot movement. Besides, in the long term mechanical components appear to be unreliable. Secondly, the disadvantage is relatively low resolution of the information about the direction of the collision of the robot or robot arm with an obstacle. For example, in the embodiment with dual hinge described above there is ability to recognize the impact from the left (approx. −20-−80 degrees), center (approx. −20-+20 degrees) and right (approx. +20-+80 degrees), conditioned by tripping one or two switches. So low resolution allows the robot to react to its collision or arm collision with an obstacle only in a limited way.

In addition, mobile robots usually have only the bumper on front of the robot—limiting collision detection only to robot's forward drive, while drive backwards is sensorless—usually no bumper on the back of the robot, such as a robot-vacuum cleaner or a robot-mop.

Finally, robotic arms are often devoid of any “bumpers” or collision sensors.

Therefore, an object of the present invention is to provide a new solution regarding the control of collision of robots or robot arms with obstacles, devoid of the above drawbacks.

Surprisingly, an accelerometer was used in order to identify non-standard accelerations, related to the collision or indicating a robot's collision with an obstacle, and in particular to identify collision strength and the direction from which the collision occurred. It turned out that it is possible to use this type of solution instead of commonly used mechanical bumper described above.

A system for controlling a robot's collision with an obstacle, according to the invention is characterized in that it includes an electronic circuit and at least one accelerometer attached to the robot and connected to an electronic circuit wherein the electronic circuit is configured and/or programmed in such way that, following the signal from the accelerometer it changes direction or speed of movement of the robot or stops the robot.

Preferably, the accelerometer is attached to the robot arm, and the electronic circuit is configured and/or programmed in such a way that, following the signal from the accelerometer it changes direction or speed of movement of the robot arm or stops the robot arm.

Preferably, the electronic system is also configured and/or programmed in such way that, following the signal from the accelerometer it sends the additional information about the obstacle to the master control unit or to the operator.

Preferably, the electronic circuit is a programmable electronic microprocessor, preferably a microcontroller of one of the following types: ARM, ATMEGA or PIC; or a CPU type processor.

The invention also includes a robot equipped with the above arrangement.

Preferably, the robot arm is equipped with the above-mentioned arrangement, in particular a programmable robot arm (ie carrying out work without supervision, such as industrial programmable).

Preferably, it is a self-propelled robot, especially an autonomous robot or teleoperated robot.

Preferably, it is a robot—a mobile robot, a home robot, a telepresence robot, a cleaning robot, a vacuuming robot, a mopping robot, a scrubbing or sweeping robot, a lawn mowing robot, a personal robot (designed for protection and for aid in homes), an EOD robot, an inspection robot, an agricultural robot, a feeding robot, a marine robot, a submerged robot, an airborne robot, a space probe robot, as well as a robot manipulation arm.

The invention also includes a method for controlling a robot's collision with an obstacle. In accordance with the invention, a method is characterized in that it comprises the following steps:
a) at least one accelerometer mounted to the robot and connected to the electronic system, in the case of collision detection, provides information of the collision in the form of signals to the electronic circuit,
b) an electronic system, following the signal from the accelerometer, changes direction or robot movement speed or stops the robot.

Preferably, the accelerometer is attached to the robot arm, and that in step b) the electronic system, following the signal from the accelerometer, changes direction or a robot arm movement speed or stops the robot arm.

Preferably, the electronic system, following the signal from the accelerometer, also sends an information about the obstacle to the master control unit or to the operator.

Preferably, the electronic system, following the signal from the accelerometer, further performs one or more activities selected from the group consisting of: an alarm, send information about the hardness of obstacles, recognize obstacles as hard, change trajectory of the fragment of the robot arm, the diagnosis of perforation of a structure.

Preferably, the electronic system, following the signal from the accelerometer, further performs one or more activities selected from the group consisting of: wake up robot from sleep mode and start working, where preferably robot turns to the direction of noted collision, directing the robot in a different direction, consistent with the direction of noted collision, cyclic switch between the local and standard operating mode, preferably between local cleaning and standard cleaning.

According to the invention, solution allows to reduce device mass and energy or fuel consumption by decreasing number of redundant mechanical components (bumpers, switches) from body of the robot. It is extremely important in case of battery powered devices enabling longer operation time on a single charging. Simultaneously elimination of spare mechanical components leads to achievement of higher reliability and durability.

By incorporating one or more precise accelerometers with additional preconfigured electronic circuits it is possible to point direction and strength of an event in three dimensional space (in terms of collision of the robot as well as robotic arm). As a result event driven reaction could be taken depending on the event parameters. Sample application could be pointed: movement direction change, change of velocity, a device stop or alarm triggering based on certain information—obstacle hardness acquired on other sensors (lidar or camera). As mentioned above it is possible to precisely determine force vector and direction in three dimensional space, hence a user gesture could be recognised and used for implementation of a suitable robot behaviour. Sample gestures was listed below but they do not cover whole set of possible applications and can be used in other mobile platforms as well as robotic arm collision detection. Compactness and interchangeability of the solution makes it superior over the most of the existing mechanical solutions incorporating mechanical bumpers.

Solution according to the invention could be implemented in mobile robots defined as a robots equipped in powertrain, chassis, wheels or tracks, capable of individual movement or autonomous devices. Autonomous robot should be meant as robot equipped in set of sensors, control unit and algorithms enabling independent device operation and performing predefined tasks without user interaction. Full autonomy can be assured by usage of rechargeable batteries and power control unit utilizing charging algorithms, cooperation with docking station capable of providing guidance signals for optimization of docking or charging process. Described in this section devices corresponds to vacuum cleaners, mopping devices, mowers or personal guarding devices.

Solution could be implemented also in robotic manipulators (also used in production lines) allowing to perform predefined actions in case of obstacle collision. In the field different than collision detection of a robot or robotics manipulator described devices could be typical and well known prior art.

### PREFERRED EMBODIMENTS OF THE INVENTION

Preferred embodiments of the present invention are presented in a more detailed way with reference to the attached drawing, wherein:

FIG. 1 (Prior art) presents a) NaviBot vacuum cleaner by Samsung; b) Scooba vacuum cleaner by iRobot; c) xv1 vacuum cleaner by Neato, d) security and surveillancel A-Bot Light by Robotics Inventions; e) fanuc robotic manipulator; f) Canda Arm 2 ISS onboard robot;

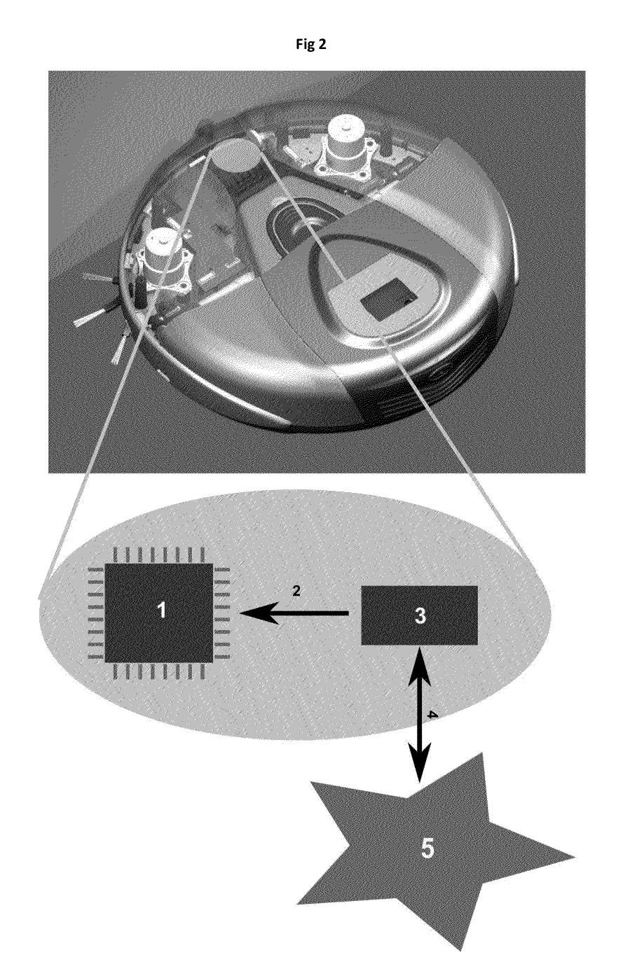

FIG. 2 briefly describes solution according to the invention;

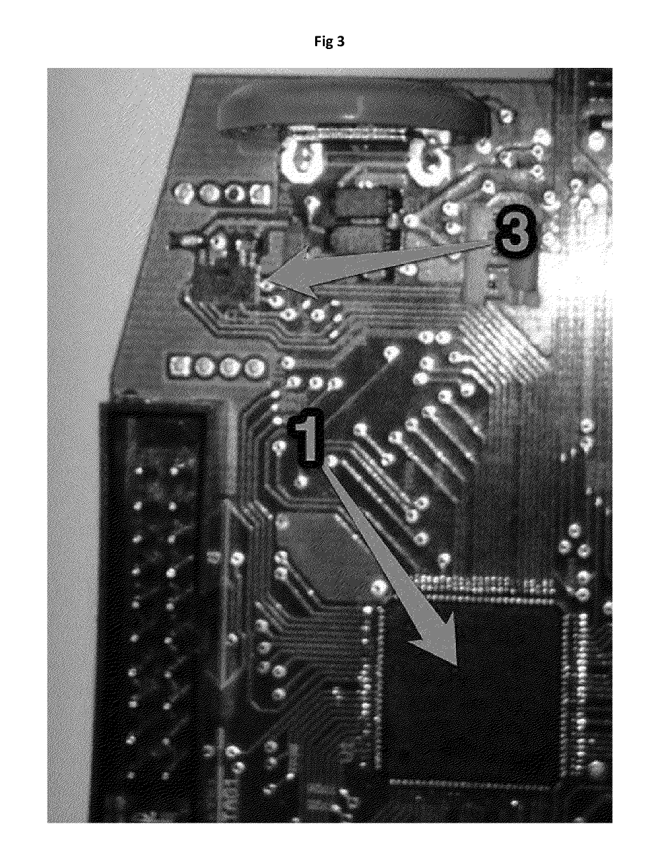

FIG. 3 presents picture of sample piece of electronic component implemented in the solution according to the invention.

Following abbreviations were used: 1—MCU=Master Control Unit, CPU=Central Processing Unit, 2—Accelerometer to MCU signal transfer, 3—accelerometer, 4—collision, 5—obstacle.

### DETAILED DESCRIPTION

Preferred embodiments of the invention are described in details below. The examples serve only as an illustration and do not limit the scope of the present invention.

According to the idea shown on FIG. 2 autonomous vacuum cleaner is equipped in collision control unit based on accelerometer 3 (fixed to the device) connected to the preprogrammed microcontroller 1.

On the FIG. 3 part of the PCB with circuit in accordance to the invention is shown. One can distinguish accelerometer 3—MMA7455 manufactured by Freescale and microcontroller 1—STM32F103VCT6, ARM Cortex-M3, manufactured by STMicroelectronics. Accelerometer 3 is soldered to the PCB which is rigidly fixed to the robot body allowing to sense even slight change in acceleration. After detecting acceleration above certain threshold, a microcontroller 1 passes information concerning direction and strength of the impact to the main program, which controls robot behaviour and movement. Main program responds to the event in the same way as in case of the mechanical bumper—changing or reversing movement direction.

Additionally program is capable of distinguishing direction and strength of the impact in full angular range (from −180 to 180 degrees). Such approach enables implementation of event driven behaviour during movement in every direction by straight or curved path and response to collision of the manipulator with obstacle. It is possible to implement different kinds of responses on incoming event: besides changing movement direction, velocity, device stop and reverse run alarm triggering or obstacle hardness can be detected as well, using other sensors, (for example a lidar/a camera detects a green obstacle—but only an impact into it confirms that these are soft straws of grass, not a small tree), recognition of the obstacle as hard (in opposition to a soft obstacle, for example a bush could be a soft drive through obstacle), exchange of the trajectory of an robot arm, information about perforation of the structure (during drill process of a skull in surgery the skull perforation is recognized by lack of the resistance).

As mentioned before there is a possibility of precise determination of force magnitude and direction in three dimensions. Further there is a possibility of preprogram advanced robot reactions on a collision for controlling robot through gestures. Gestures examples:
“start working”—system powers up from standby and starts working (robot heading is set corresponding to a kick or a pat direction)
“move back”—potential robot collision with a human may cause a hit or a kick. The latter is detected as a stronger impact (impulse of an acceleration) than typical hit during casual bumps. In this particular situation robot reaction goes in opposite direction to the kick direction instead of typical avoidance procedure (which can cause several collisions with standing person);
“work mode switch: local/standard”—Working mode change between local cleaning (spot cleaning with specific cleaning parameters—i.e. full vacuum power or better coverage, using fluid, brushes or with scrubbing) and standard cleaning could be made by more than one kick or hit. Following kicks/hits sequences switch alternately between this two working mode.

Robot covers whole room surface (that is whole surface is cleaned). After hitting obstacle robot changes his route and pass obstacle.

Having thus described several aspects of at least one embodiment of this disclosure implemented on a cleaning home robot as a mean of the control of the collision of the robot with an obstacle is to be implemented in various robots, among others in mobile robots, home robots, telepresence robots, cleaning robots, vacuuming robots, mopping robots, scrubbing or sweeping robots, lawn mowing robots, personal robots (designed for protection and for aid in homes), EOD robots, inspection robots, agriculture robots, feeding robots, marine robots, submerged robots, airborne robots, space probe robots, as well as robot manipulation arms. The mentioned apparatuses, with the exception of the described disclosure of the method of the control of the collision of a robot or a robot arm with an obstacle, may retain an existing typical construction unaltered for those skilled in prior art. Such described alterations, modifications, and improvements are intended to be part of this disclosure, and are intended to be within the spirit and scope of the disclosure.

1. A robot collision control system characterized in that it comprises an electronics system (1) and at least one accelerometer (3), fixed to robot and connected to electronics system (1), wherein the electronics system (1) is configured and/or programmed whereupon an accelerometer signal (3) a robot heading direction or velocity is changed or the robot is stopped.

2. The system according to claim 1, characterized in that the accelerometer (3) is fixed to a robot arm, wherein the electronics system (1) is configured and/or programmed whereupon the accelerometer signal (3) the robot arm movement direction or velocity is changed or stopped.

3. The system according to claim 1, characterized in that the electronics system (1) is configured and/or programmed whereupon the accelerometer signal (3), additionally sends to a parent unit or an operator information about obstacles.

4. The system according to claim 1, characterized in that the electronics system (1) is programmed, an electronics microprocessor, favourably an ARM, ATMEGA, PIC microcontroller or a CPU type processor.

5. A robot equipped with the system according to claim 1.

6. A robot equipped with an arm further comprising a system according to claim 1, configured as a programmable robot arm.

7. A robot according to claim 5, characterized in that it is a unmanned moving robot, configured to be autonomous.

8. A robot according to claim 5, characterized in that it is a mobile robot, a home robot, a telepresence robot, a cleaning robot, a vacuuming robot, a mopping robot, a scrubbing or sweeping robot, a lawn mowing robot, a personal robot (designed for protection and for aid in homes), an EOD robot, an inspection robot, an agriculture robot, a feeding robot, a marine robot, a submerged robot, an airborne robot, a space probe robot.

9. A collision control method of a robot with an obstacle, characterized in that it comprises the steps:
a) at least one accelerometer (3) fixed to the robot and connected to the electronics system (1), whereupon a detected collision, sends information about a collision in a form of signals to the electronics system (1);
b) the electronics system (1), whereupon a signal from an accelerometer (3), changes the robot heading direction or velocity or stops the robot.

10. A method according to claim 9, characterized in that the accelerometer is fixed to the robot arm, and in phase b) the electronics system (1), whereupon accelerometer signal (3) the robot arm heading direction or velocity is changed or the robot arm is stopped.

11. A method according to claim 9, characterized in that the electronics system (1) is configured and/or programmed whereupon accelerometer signal (3), additionally sends to a parent unit or an operator information about obstacles.

12. A method according to claim 9, characterized in that the electronics system (1) is programmed, electronics microprocessor, favourably an ARM, ATMEGA, PIC microcontroller or a CPU type processor.

13. A method according to claim 9, characterized in that the electronics system (1) is configured and/or programmed whereupon the accelerometer signal (3), additionally performs one or more actions from an action group comprising an alarm trigger, sending information on hardness of an obstacle, sending an identification of the obstacle as a hard obstacle, change of the trajectory of a robot arm section, identification of a structure perforation.

14. A method according to claim 9, characterized in that the electronics system (1) whereupon the accelerometer signal (3), additionally performs one or more actions from the group consisting of: wake up robot from sleep mode and start working, where preferably robot turns to the direction of noted collision, directing the robot in a different direction, consistent with the direction of noted collision, cyclic switch between the local and standard operating mode, preferably between local cleaning and standard cleaning.
